(19) United States
(12) Patent Application Publication
(10) Pub. No.: US 2011/0013580 A1
(43) Pub. Date: Jan. 20, 2011

(54) COMMUNICATION METHOD AND A BASE STATION APPARATUS USING THE METHOD

(75) Inventor: Yuki Nakasato, Gifu (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Fushimi-ku (JP)

(21) Appl. No.: 12/921,127

(22) PCT Filed: Mar. 5, 2009
(86) PCT No.: PCT/JP2009/054156

§ 371 Date: Sep. 3, 2010

(30) Foreign Application Priority Data
Mar. 6, 2008 (JP) 2008-056614 2008

(51) Int. Cl. H04W 76/02

(52) U.S. Cl. 370/329

(57) ABSTRACT

One objective of the present invention is to reduce influence to EDCHs even in case of an error occurring in one ECCH. In order to achieve this objective, the present invention provides a base station apparatus, in which frames formed with a plurality of channels are continuously arranged, the base station apparatus comprising a control unit (30) for allocating different channels, in each frame, to EDCHs for communication between the base station apparatus and terminal devices and to an ECCH for the EDCHs, and an RF unit (20) and an IF unit (26) for implementing communication with terminal devices using the ECCH and the EDCHs to which channels have been allocated, and characterized in that an ECCH in one frame corresponds to EDCHs over a plurality of frames.

### TECHNICAL FIELD

The present invention relates to communication technology, more particularly, to a communication method for communicating with terminal devices using channels allocated to the terminal devices and a base station apparatus using the method.

### BACKGROUND ART

In a radio communication system, there is a case where a base station apparatus is accessed by a plurality of terminal devices. One of schemes used when a base station apparatus is accessed by a plurality of terminal devices is TDMA (Time Division Multiple Access)/TDD (Time Division Duplex). In TDMA/TDD, a frame is formed with a plurality of time slots, and a plurality of frames are continuously arranged. Parts of a plurality of time slots contained in one frame are used for uplinks, and the remaining is used for downlinks. In such TDMA/TDD, for example, the number of time slots used for uplinks and the number of time slots used for downlinks are set to correspond with traffic (see, in particular, Patent Document 1).

[Patent Document 1] Japanese Patent Application Publication No. Hei 8-186533-A

### DISCLOSURE OF THE INVENTION

### Problem to be Solved by the Invention

In radio communication, effective use of limited frequency resources has been demanded. This demand is increasing with the high speed of communication. One of technologies to meet the demand is OFDMA (Orthogonal Frequency Division Multiple Access), which can be combined with TDMA/TDD described above. OFDMA is a technology, which frequency multiplexes a plurality of terminal devices while using OFDM. Thus, in a combination of OFDMA and TDMA (hereinafter, “OFDMA” without distinction from general OFDMA), a plurality of sub-channels defined in a frequency axis direction and a plurality of time slots defined in a time axis direction exist. Further, a combination of the sub-channels and the time slots (hereinafter, it is referred as “burst”) is used for a communication.

In OFDMA, a base station apparatus periodically allocates bursts for data communication to each terminal device. This burst allocation is referred as a “circuit switching scheme,” which is useful for communication requiring minimum transmission delay such as a voice call. Meanwhile, there is communication, such as data communication, in which traffic significantly fluctuates, while minimum transmission delay is not required. For the latter communication, rather than the circuit switching scheme, a “random access scheme,” which varies the number of bursts to be allocated to terminal devices in the unit of frames to correspond with traffic, is suitable. In the random access scheme, there is a case where a plurality of bursts per frame are allocated to terminal devices. In the bursts, a channel containing data (hereinafter, an “EDCH”) is placed. Information about an EDCH is included in an ECCH, which is periodically allocated. Thus, when an error occurs in an ECCH, it is not possible to receive an EDCH as well as the ECCH, namely, the influence of the error becomes significant.

The present invention is made in view of such circumstances, and its objective is to provide communication technology, in which even if an error occurs in an ECCH, the influence of the error to an EDCH is reduced.

### Means for Solving the Problems

In order to resolve the technical problem, one aspect of the present invention provides a base station apparatus, in which frames formed with a plurality of channels are continuously arranged, the apparatus comprising an allocation unit for allocating different channels, in each frame, to data for communication between the base station apparatus and a terminal device and to control information of the data, respectively, and a communication unit for implementing communication with the terminal device using the control information and the data, to which the channel has been allocated by the allocation unit. The control information, to which the channel has been allocated by the allocation unit, and which is within one frame, corresponds to data over a plurality of frames.

Another aspect of the present invention provides a communication method. According to this communication method, frames formed with a plurality of channels are continuously arranged such that in each frame, different channels are allocated to data for communication between the base station apparatus and a terminal device and to control information of the data, respectively, and then communication with terminal device is implemented using the control information and the data, to which the channel has been allocated. The control information, to which the channel has been allocated, and which is within one frame, corresponds to data over a plurality of frames.

Aspects of the present invention include any combination of the elements stated above and modifications in expression, such as a method, a device, a system, a record medium, a computer program, and so on.

### ADVANTAGES OF THE PRESENT INVENTION

According to the present invention, even if an error occurs in an ECCH, the influence to an EDCH can be reduced.

### BRIEF DESCRIPTION OF THE DRAWINGS

FIG. 1 shows a configuration of the communication system according to an embodiment of the present invention.

FIG. 2 shows a configuration of TDMA frames in the communication system of FIG. 1.

FIG. 3 shows a configuration of OFDMA sub-channels in the communication system of FIG. 1.

FIG. 4 shows a configuration of a sub-channel block in the communication system of FIG. 1.

FIG. 5 shows a configuration of a control channel in the communication system of FIG. 1.

FIG. 6 is a sequence chart showing the sequence of TCH synchronization establishment in the communication system of FIG. 1.

FIG. 7 shows a configuration of the base station apparatus of FIG. 1.

FIG. 8(a) and FIG. 8(b) show a format of a downlink ECCH in the communication system of FIG. 1.

FIG. 9(a) and FIG. 9(b) show a format of an uplink ECCH in the communication system of FIG. 1.

FIG. 10 shows transmission operation of an ECCH and an EDCH in a communication system comparable to the communication system of FIG. 1.

FIG. 11 shows transmission operation of a downlink ECCH in the communication system of FIG. 1.

FIG. 12 shows transmission operation of an uplink ECCH in the communication system of FIG. 1.

FIG. 13 shows transmission operation in the communication system of FIG. 1 when an error occurs in a downlink ECCH.

FIG. 14 shows transmission operation in the communication system of FIG. 1 when an error occurs in an uplink ECCH.

FIG. 15 shows other transmission operation in the communication system of FIG. 1 when an error occurs in an uplink ECCH.

### DESCRIPTION OF REFERENCE NUMERALS

10: base station
12: terminal
20: RF unit
22: modulation/demodulation unit
24: baseband processing unit
26: IF unit
30: control unit
50: access unit
52: allocation unit
54: generation unit
56: delay unit
58: synthesis unit
100: communication system

### BEST MODE FOR CARRYING OUT THE INVENTION

The present invention is summarized below prior to detailed description thereof. An embodiment of the present invention relates to a communication system comprising a base station apparatus and at least one terminal device. In the communication system, each frame is formed with a plurality of time slots being time-division multiplexed, and each time slot is formed with a plurality of sub-channels being frequency-division multiplexed. Each sub-channel is formed with multicarrier signals. For the multicarrier signals, OFDM signals are used. For the frequency-division multiplexing, OFDMA is used. The base station apparatus implements communication with a plurality of terminal devices by allocating each of a plurality of sub-channels contained in each time slot to the terminal devices.

There exist a plurality of types of data, which are the object of communication with a plurality of terminal devices. In addition, different communication speed or different delay time is required according to types of data. For example, voice communication generally requires shorter delay time than that for data communication. In addition, for data communication, the communication speed varies depending on data contents. Thus, when short delay time is required, it is desirable to periodically allocate bursts as done in the circuit switching scheme. For example, a base station apparatus periodically allocates bursts in a frame period. Meanwhile, if the circuit switching scheme is applied to a terminal device not requiring short delay time, it will cause unnecessary allocations and make it difficult to respond to the fluctuation of data amounts.

Thus, data communication employs the random access scheme, which allows a base station apparatus to randomly allocate bursts to each terminal device. Hereinafter, in the random access scheme, a channel of data to be allocated to a burst will be referred to as an “EDCH.” In the random access scheme, control information (hereinafter, an “ECCH”) about an EDCH is generated in the unit of frames. An ECCH includes information about a burst in which an EDCH is placed, a communication speed of an EDCH, and others. A base station apparatus periodically implements communication with each terminal device using an ECCH. A terminal device receives an ECCH and confirms the content of the ECCH to perceive a burst to which an EDCH is allocated. As described, if an error occurs in an ECCH, it is concerned that an EDCH as well as the ECCH cannot be received, namely, the influence of the error becomes significant.

In order to resolve this problem, the base station apparatus according to an embodiment of the present invention allows one ECCH to include information about EDCHs over a plurality of frames. For example, in a related art case where information about an EDCH in the next second frame is included in an ECCH, an embodiment of the present invention allows the ECCH to also include information about an EDCH in the next frame, in addition to the information about the EDCH in the next second frame. Thus, even if an error occurs in a particular ECCH, an ECCH in the next frame includes overlapping information about an EDCH so that EDCH communication is possible.

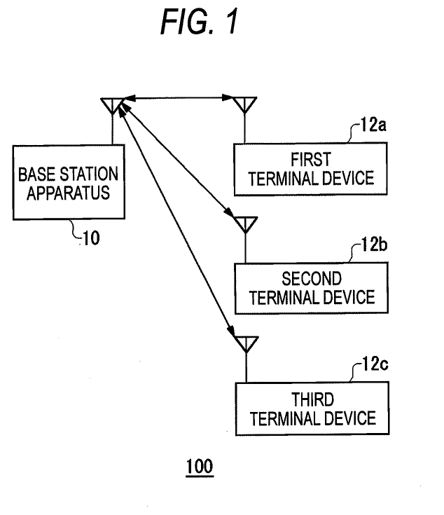

FIG. 1 shows a configuration of the communication system (100) according to an embodiment of the present invention. The communication system (100) comprises a base station apparatus (10), and a first terminal device (12a), a second terminal device (12b), and a third terminal device (12c), which are generically named as “terminal devices (12).”

One end of the base station apparatus (10) is accessed by the terminal devices (12) through a wireless network, and the other end is accessed by a wired network not illustrated herein. The terminal devices (12) are accessed to the base station apparatus (10) through a wireless network. Since the base station apparatus (10) has a plurality of time slots and a plurality of sub-channels, it implements TDMA using the plurality of time slots and OFDMA using the plurality of sub-channels. As described above, a combination unit of time slots and sub-channels is defined as a burst. The base station apparatus (10) allocates bursts to each of the plurality of terminal devices (12) to implement communication with the plurality of terminal devices (12). More specifically, the base station apparatus (10) defines one of a plurality of sub-channels as a control channel. Through the control channel, the base station apparatus (10) periodically transmits a notification signal such as a BCCH.

The terminal devices (12) receive a BCCH to perceive the existence of the base station apparatus (10) and request a ranging from the base station apparatus (10). The base station apparatus (10) responds to the ranging request. A ranging is a process to correct frequency offsets and timing offsets of the terminal devices (12). Since a well-known ranging technique can be used, explanation thereof is omitted herein. Thereafter, the terminal devices (12) transmit burst allocation request signals to the base station apparatus (10). In response to the received request signals, the base station apparatus (10) allocates bursts to the terminal devices (12). The communication system (100) employs two allocation schemes, i.e., the circuit switching scheme and the random access scheme.

The base station apparatus (10) transmits information about the bursts allocated to the terminal devices (12). The terminal devices (12) implement communication with the base station apparatus (10) using the allocated bursts. As a result, data transmitted from the terminal devices (12) are outputted through the base station apparatus (10) to a wired network and finally received to a communication device, not illustrated herein, accessed to the wired network. The data are also transmitted in the direction from the communication device to the terminal devices (12). The base station apparatus (10) allocates an ECCH in the unit of frames to the terminal devices (12) executing the random access scheme. The base station apparatus (10) also allocates EDCHs to the corresponding terminal devices (12). That is, in one frame, different bursts for the respective EDCHs and ECCH are allocated. The number of EDCHs in a frame varies according to each frame. Control information about EDCHs is included in an ECCH. For example, bursts in a frame to which EDCHs have been allocated, a communication speed of EDCHs, and others are included in an ECCH. This will be described in detail later.

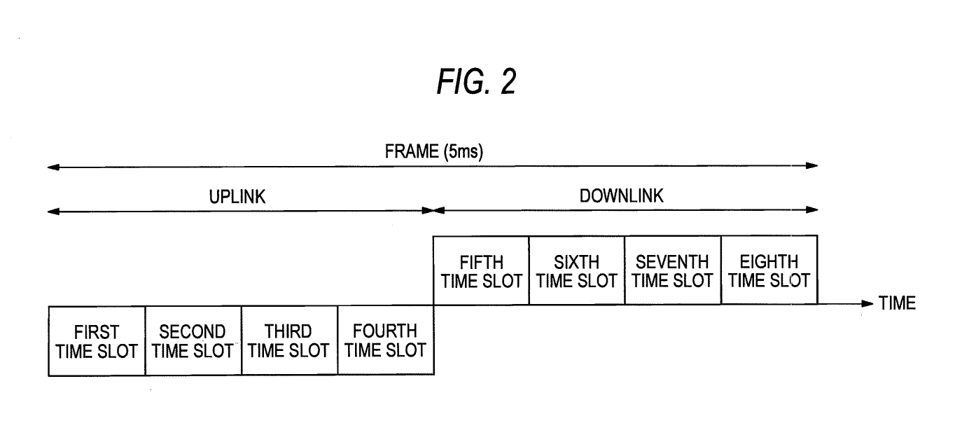

FIG. 2 shows a configuration of TDMA frames in the communication system (100). In the communication system (100), a frame is formed with 4 time slots for uplink communication and 4 time slots for downlink communication, like a second-generation codeless telephone system. The 4 time slots for uplink communication correspond to uplink sub-frames. The 4 time slots for downlink communication correspond to downlink sub-frames. In addition, frames are continuously arranged. In an embodiment of the present invention, allocation of time slots for uplink communication is the same as allocation of time slots for downlink communication. Thus, for convenience, only downlink communication may be explained hereinafter.

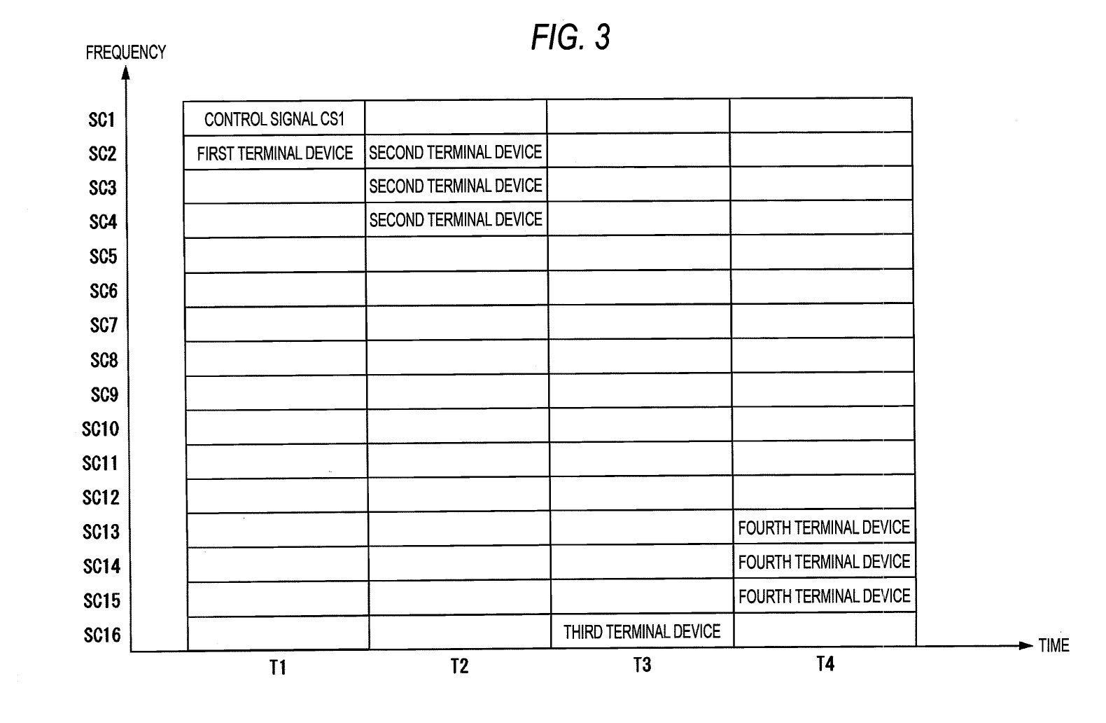

FIG. 3 shows a configuration of OFDMA sub-channels in the communication system (100). The base station apparatus (10) applies OFDMA as illustrated in FIG. 3, in addition to TDMA that has been described. As a result, a plurality of terminal devices are allocated to one time slot. In FIG. 3, the horizontal direction relates to arrangement of time slots on a time axis, and the vertical direction relates to arrangement of sub-channels on a frequency axis. In other words, the multiplexing in the horizontal direction is TDMA, and the multiplexing in the vertical direction is OFDMA. In the configuration, one frame contains a first time slot (“T1” in FIG. 3) to a fourth time slot (“T4” in FIG. 3). For example, T1 to T4 in FIG. 3 correspond to the fifth time slot to the eighth time slot in FIG. 2, respectively.

Each time slot contains a first sub-channel (“SC1” in FIG. 3) to a sixteenth sub-channel (“SC16” in FIG. 3). In FIG. 3, the first sub-channel is established as a control channel. In the drawing, the first base station apparatus (10a) (“CS1” in FIG. 3) allocates a control signal to the first sub-channel of the first time slot. That is, the frame configuration only in terms of SC1 and the aggregation of a plurality of frames correspond to a LCCH. In addition, in FIG. 3, the first terminal device (12a) is allocated to the second sub-channel of the first time slot. The second terminal device (12b) is allocated to the second sub-channel to the fourth sub-channel of the second time slot. The third terminal device (12c) is allocated to the sixteenth sub-channel of the third time slot. The fourth terminal device (12d) is allocated to the thirteenth sub-channel to the fifteenth sub-channel of the fourth time slot. The burst allocated to the first terminal device (12a) and the burst allocated to the third terminal device (12c) correspond to an ECCH.

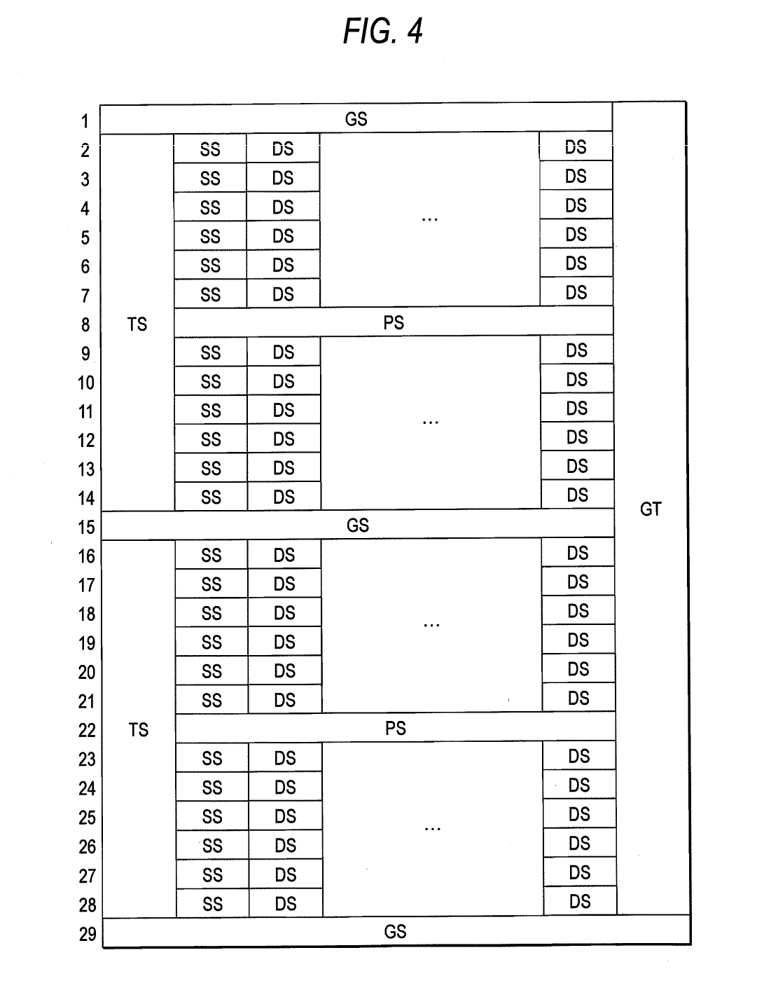

FIG. 4 shows a configuration of a sub-channel block in the communication system (100). A sub-channel block is a radio channel specified with time slots and sub-channels. In FIG. 4, the horizontal direction relates to a time axis, and the vertical direction relates to a frequency axis. The numerals, “1” to “29,” refer to numbers of subcarriers. Like this, a sub-channel consists of OFDM multicarrier signals. In FIG. 4, “TS” is a training symbol, which includes known signals, such as “STS,” a symbol for synchronization detection, and “LTS,” a symbol for estimation of a characteristic of a transmission channel, which are not illustrated. “GS” is a guard symbol, in which no effective signal is placed. “PS” is a pilot symbol, which consists of a known signal. “SS” is a signal symbol, in which a control signal is placed. “DS” is a data symbol, namely, refers to data to be transmitted. “GT” is a guard time, in which no effective signal is placed.

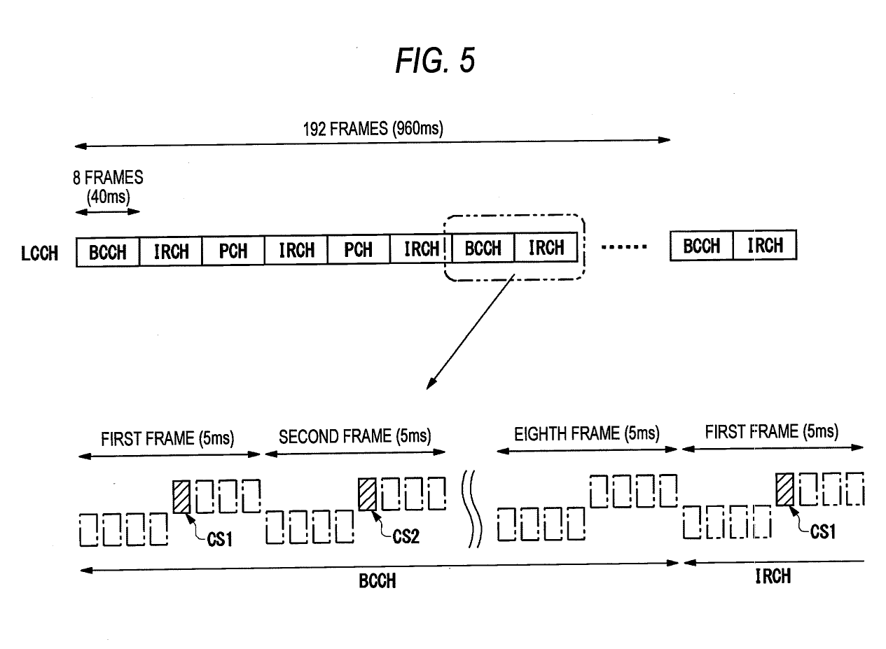

FIG. 5 shows a configuration of a control channel in the communication system (100). The control channel consists of 24 channels, which include 4 BCCHs, 12 IRCHs, and 8 PCHs. Each of BCCHs, IRCHs, and PCHs consists of 8 TDMA frames (hereinafter, “frames”). One frame is configured as shown in FIG. 2. For convenience, in FIG. 5, the terms, “PCH,” “BCCH” and “IRCH” are used to also include frames in which PCHs, BCCHs, and IRCHs are placed. In addition, as described above, a frame is divided into a plurality of time slots. Herein, the terms, “PCH,” “BCCH,” and “IRCH” are used without distinction of the time slot unit, the frame unit, and the 8-frame unit.

In FIG. 5, an “IRCH” is an initial ranging channel used when allocating channels. More specifically, an “IRCH” contains a “TCCH” and an “IRCH,” in which the “TCCH” corresponds to an initial ranging request transmitted from the terminal devices (12) to the base station apparatus (10), and the “IRCH” corresponds to a response to the initial ranging request. Thus, the “TCCH” is an uplink signal, and the “IRCH” is a downlink signal (hereinafter, a combination of the TCCH and the IRCH will also be referred to as an “IRCH” without distinction from the term, “IRCH” solely). The base station apparatus receiving a TCCH from the terminal devices executes a ranging process. Since a well-known ranging technique can be used, explanation thereof is omitted herein.

The lower portion of FIG. 5 shows a configuration of each frame, which is the same as illustrated in FIG. 2. This configuration also corresponds to the frame configuration for SC1 in FIG. 4. The first base station apparatus (10a) in FIG. 1 transmits BCCHs, IRCHs, and PCHs at 8-frame intervals in a time slot (“CS1” in FIG. 5), to which a LCCH is allocated, among time slots constituting a frame. In other words, the first base station apparatus (10a) uses a fifth time slot of a first frame among eight frames constituting an BCCH, and a fifth time slot of a first frame among eight frames constituting an IRCH.

Furthermore, the first base station apparatus (10a) uses a fifth time slot of a first frame among eight frames constituting a PCH. The second base station apparatus (10b) illustrated in FIG. 1 transmits BCCHs, IRCHs, and PCHs at 8-frame intervals in a time slot (“CS2” in FIG. 5), which has the same position from the frame head as the time slot being used by the first base station apparatus (10a), among time slots of a frame (a second frame in FIG. 5) next to the frame in which the transmission by the first base station apparatus (10a) was made. According to this configuration, each of 4 downlink time slots constituting a frame can multiplex 8 base station apparatuses such that maximum 32 base station apparatuses can be multiplexed.

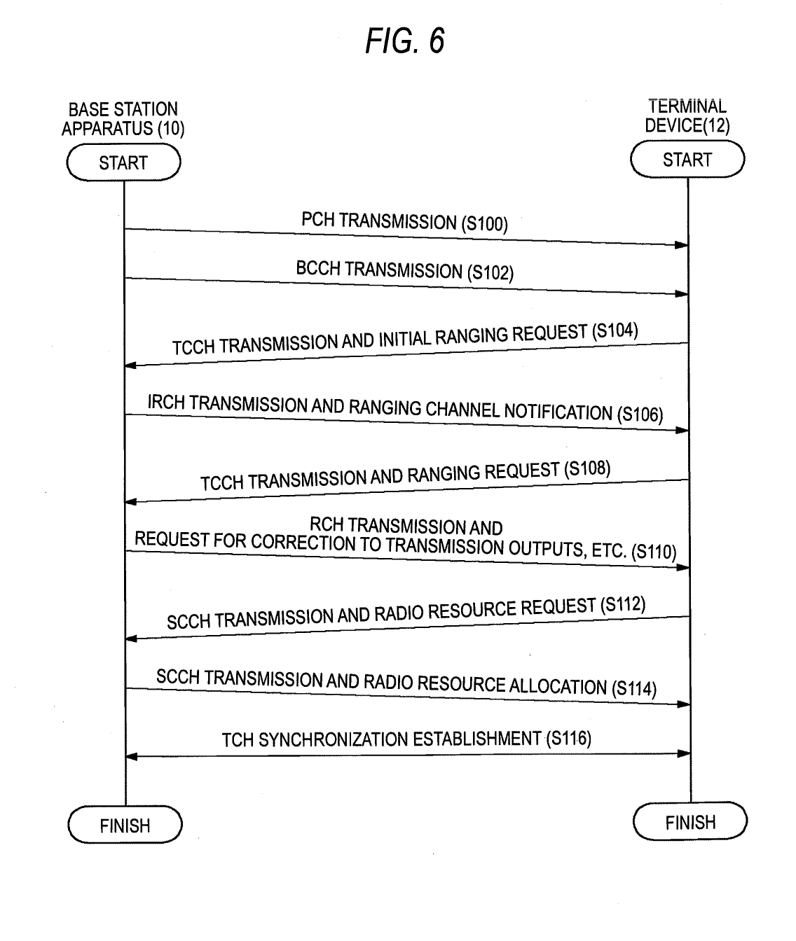

FIG. 6 is a sequence diagram showing the sequence of TCH synchronization establishment in the communication system (100). This sequence diagram is related to the case where the circuit switching scheme stated above is executed. The base station apparatus (10) stores terminal numbers of the terminal devices (12) and simultaneously transmits PCHs together with other base station apparatuses within a paging area (S100). The base station apparatus (10) transmits BCCHs at a predetermined timing (S102). The terminal devices (12) receiving PCHs specify the base station apparatus (10) based on the BCCHs if their terminal numbers are included in the PCHs, and then store transmission source identification information in TCCHs to transmit them to the base station apparatus (10) and request a first initial ranging (S104). A TCCH is a signal defined to request an initial ranging, which is defined with a plurality of types of waved patterns. The base station apparatus (10) separates the transmission source identification information (UID) of the terminal devices (12) from the received TCCHs, and allocates empty TCHs to the terminal devices (12). The base station apparatus (10) stores slot numbers and sub-channel numbers of the allocated TCHs in IRCHs and transmit them to the terminal devices (12) to notify the terminal devices (12) of TCHs to perform a second initial ranging (S106). The terminal devices (12) store transmission source identification information in TCCHs and transmit them to the base station apparatus (10) by using the TCHs allocated for an initial ranging to request a second initial ranging (S108).

The base station apparatus (10) performs a ranging process by using the TCHs allocated to the terminal devices (12) and stores time alignment control, transmission output control, and SCCH transmitting and receiving timing in RCHs to transmit them to the terminal devices (12) and request correction to transmission outputs, etc., (S110). The terminal devices (12) extract correction values requested by the base station apparatus (10) from the received RCHs and correct transmission outputs, etc. Hereinafter, these processes will be referred to as a “ranging process.” Thereafter, by using the TCHs allocated for an initial ranging, the terminal devices (12) request the base station apparatus (10) to allocate radio resources (S112). The base station apparatus (10) performs a FEC decoding process, etc., for the radio resource allocation request message from the terminal devices (12), and then allocates empty TCHs to the terminal devices (12). Then, the base station apparatus (10) stores slot numbers and sub-channel numbers of the allocated TCHs in SCCHs and transmits them to the terminal devices (12) (S114). Since synchronization of TCHs is established by the foregoing processes, the base station apparatus (10) and the terminal devices (12) transmit and receive data thereafter by using the TCHs of which synchronization has been established (S116).

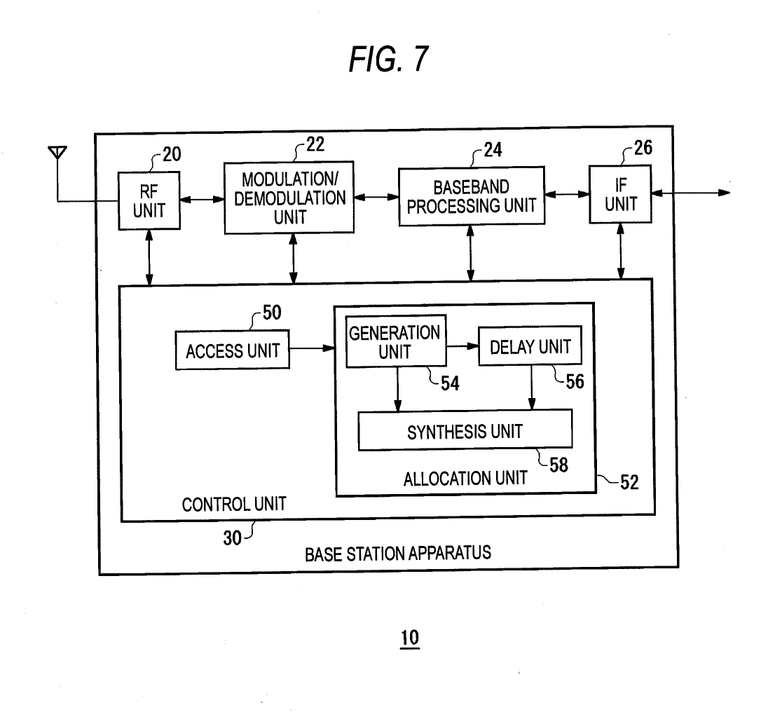

FIG. 7 shows a configuration of the base station apparatus (10). The base station apparatus (10) comprises a RF unit (20), a modulation/demodulation unit (22), a baseband processing unit (24), an IF unit (26), and a control unit (30). The control unit (30) comprises an access unit (50) and an allocation unit (52). The allocation unit (52) comprises a generation unit (54), a delay unit (56), and a synthesis unit (58).

With respect to receiving processes, the RF unit (20) performs frequency conversion for radio frequency multicarrier signals received from the terminal devices (12) not illustrated herein and generates baseband multicarrier signals. The multicarrier signals are formed as shown in FIG. 3 and correspond to the uplink time slots in FIG. 2. Furthermore, the RF unit (20) outputs the baseband multicarrier signals to the modulation/demodulation unit (22). Generally, since a baseband multicarrier signal is formed with an in-phase component and an orthogonal component, it should be transmitted through two signal lines. However, for clarity in drawings, only one signal line is illustrated. The RF unit (20) also comprises an AGC or AD conversion unit.

With respect to transmitting processes, the RF unit (20) performs frequency conversion for the baseband multicarrier signals inputted from the modulation/demodulation unit (22) and generates radio frequency multicarrier signals. Furthermore, the RF unit (20) transmits the radio frequency multicarrier signals. The RF unit (20) transmits the multicarrier signals by using the same radio frequency band as that for the received multicarrier signals. That is, TDD is used as illustrated in FIG. 2. The RF unit (20) also comprises a PA (Power Amplifier) and D/A conversion unit.

With respect to receiving processes, the modulation/demodulation unit (22) performs FFT for the baseband multicarrier signals inputted from the RF unit (20) so as to convert the time domain into the frequency domain. The multicarrier signals that have converted into the frequency domain have components corresponding to the respective plurality of subcarriers as illustrated in FIG. 3 or FIG. 4. The modulation/demodulation unit (22) also performs timing synchronization, i.e., setting of FFT window, and deletion of guard intervals. Since a well-known timing synchronization technique can be used, explanation thereof is omitted herein. In addition, the modulation/demodulation unit (22) demodulates the multicarrier signals that have converted into the frequency domain. For the demodulation, a transmission channel characteristic is estimated. Estimation of a transmission channel characteristic is made in the unit of subcarriers. The modulation/demodulation unit (22) outputs the demodulation result to the baseband processing unit (24).

With respect to transmitting processes, the modulation/demodulation unit (22) performs modulation for the multicarrier signals received from the baseband processing unit (24). In addition, the modulation/demodulation unit (22) performs IFFT for the modulated multicarrier signals so as to convert the frequency domain into the time domain. The modulation/demodulation unit (22) outputs the multicarrier signals that have converted into the time domain to the RF unit (20) as baseband multicarrier signals. The modulation/demodulation unit (22) also performs addition of guard intervals, which is not explained herein.

With respect to receiving processes, the baseband processing unit (24) receives the demodulation result from the modulation/demodulation unit (22) and divides the demodulation result into units of the terminal devices (12). In other words, the demodulation result consists of a plurality of sub-channels as illustrated in FIG. 3. Thus, in case where one sub-channel is allocated to one of the terminal devices (12), the demodulation result includes signals from a plurality of the terminal devices (12). The baseband processing unit (24) divides such a demodulation result into units of the terminal devices (12). The baseband processing unit (24) adds information for identification of the terminal devices (12) as transmission sources and information for identification of destination to the divided demodulation result and outputs it to the IF unit (26).

With respect to transmitting processes, the baseband processing unit (24) receives from the IF unit (26) data toward the plurality of the terminal devices (12), allocates the data to sub-channels, and forms a multicarrier signal from the plurality of sub-channels. That is, the baseband processing unit (24) forms a multicarrier signal consisting of a plurality of sub-channels as illustrated in FIG. 3. Sub-channels to which data should be allocated are already decided as illustrated in FIG. 3. Instructions thereon are received from the control unit (30). The baseband processing unit (24) outputs the multicarrier signal to the modulation/demodulation unit (22).

With respect to receiving processes, the IF unit (26) outputs the demodulation result received from the baseband processing unit (24) to a wired network not illustrated herein. Destination of the demodulation result is determined based on the information that has been added to the demodulation result in order to identify the destination. Information to identify destination is disclosed, for example, by an IP (Internet Protocol) address. With respect to transmitting processes, the IF unit (26) inputs data for the plurality of the terminal devices (12) from a wired network not illustrated herein. The control unit (30) outputs the inputted data to the baseband processing unit (24).

The control unit (30) performs allocation of bursts to the terminal devices (12) and timing control for the entire base station apparatus (10). Allocation of bursts corresponds to allocation of a combination of sub-channels and time slots. As described above, the control unit (30) executes the circuit switching scheme and the random access scheme for allocation of bursts. For example, the control unit (30) executes the circuit switching scheme in response to requests from the terminal devices (12). In other words, the control unit (30) periodically allocates bursts to the terminal devices (12). For example, bursts contained in time slots of a frame period are allocated to the first terminal device (12a). Allocation of bursts has only to be periodically performed and is not limited to a frame period, namely, may be performed in a longer or shorter period than a frame period.

In addition, the control unit (30) executes the random access scheme in response to requests from other terminal devices (12). That is, the control unit (30) modifies allocation of bursts to the corresponding terminal devices (12) in the unit of frames. For example, the control unit (30) decides the number of bursts to be allocated while reflecting traffic with the terminal devices (12). The control unit (30) periodically allocates an ECCH to the terminal devices (12) and allows the ECCH to include information of bursts to which EDCHs have been allocated. In this case, the control unit (30) notifies the allocation of an ECCH when transmitting SCCHs. Thus, an ECCH is periodically allocated like a TCH in the circuit switching scheme. In addition, as a TCH includes a downlink TCH and an uplink TCH, an ECCH includes a downlink ECCH and an uplink ECCH.

The operation of the control unit (30) will be explained more in detail. In particular, (a) operation in case of new access, (b) basic operation in the random access scheme, and (c) details of an ECCH in the random access scheme, which are closely related to an embodiment of the present invention, will be described. The details in (c) are part of the operation described in (b). Additionally, for clear explanation, processing one of the terminal devices (12) will be explained.

(a) Operation in Case of New Access

After a ranging process is finished, the access unit (50) receives a radio resource acquisition request SCCH from the terminal device (12), not illustrated herein and not subject to access, through the RF unit (20) to the IF unit (26). The access unit (50) allocates bursts to the corresponding terminal device (12) based on the radio resource acquisition request SCCH. In this case, for example, the radio resource acquisition request SCCH may include information as to whether allocation using the circuit switching scheme or allocation using the random access scheme is desired. The access unit (50) decides allocation using the circuit switching scheme or the random access scheme based on the information. In either case, symmetric busts should be allocated to uplink sub-frames and downlink sub-frames. If the circuit switching scheme is executed, the access unit (50) directly allocates a TCH, i.e., a bust which will have to include data, to the terminal device (12).

If the random access scheme is executed, the access unit (50) directly allocates an ECCH, i.e., a burst which already includes information about an EDCH, to the terminal device (12). Allocation of a burst for an EDCH is delivered via an ECCH to the terminal device (12). The access unit (50) transmits the result of the TCH allocation in the circuit switching scheme or the result of the ECCH allocation in the random access scheme as a radio resource allocation SCCH through the IF unit (26) and the RF unit (20) to the terminal device (12) not illustrated herein. The non-illustrated terminal device (12) implements communication based on the radio resource allocation SCCH. In addition, the RF unit (20) through the IF unit (26) implement communication with the terminal device (12) using the ECCH and the EDCH to which busts have been allocated in the control unit (30).

(b) Basic Operation in the Random Access Scheme

The control unit (30) decides bursts to be allocated to an EDCH in the unit of frames. Allocation of bursts to an EDCH is performed for a respective uplink EDCH and downlink EDCH. The control unit (30) stores the result of burst allocation to a respective uplink EDCH and downlink EDCH in a downlink ECCH. A downlink ECCH also includes a communication speed and other information about a downlink EDCH. A communication speed is determined by a modulation method and a coding rate of error corrections.

Furthermore, a downlink ECCH includes ACK/NACK information of a past uplink EDCH. The ACK/NACK information is used for ARQ (Automatic Repeat Request) or HARQ, which are not explained herein. An uplink ECCH is transmitted from the terminal device (12) not illustrated herein and includes a communication speed information about an uplink EDCH or ACK/NACK information of a past downlink EDCH. In addition, after notification of an ECCH, EDCH communication is implemented between the base station apparatus (10) and the terminal device (12) based on the information included in the ECCH.

(c) Details of an ECCH in the Random Access Scheme

The generation unit (54) generates information (hereinafter, “EDCH information”), which is a base of a downlink ECCH. EDCH information includes information about a burst, in which an EDCH is placed, in a frame, communication speed information about an EDCH, and ACK information about a past uplink EDCH. This information corresponds to EDCHs in the next second frame. The generation unit (54) outputs the generated EDCH information to the delay unit (56) and the synthesis unit (58).

The delay unit (56) receives the EDCH information generated in the generation unit (54). The delay unit (56) delays the received EDCH information by one frame and outputs it to the synthesis unit (58). The synthesis unit (58) receives the corresponding EDCH information in the next second frame from the generation unit (54) and the corresponding EDCH information in the next frame from the delay unit (56). In other words, the synthesis unit (58) receives corresponding EDCH information over continuous frames. The synthesis unit (58) synthesizes two EDCHs to generate an ECCH. In other words, one ECCH corresponds to EDCHs in two continuous frames.

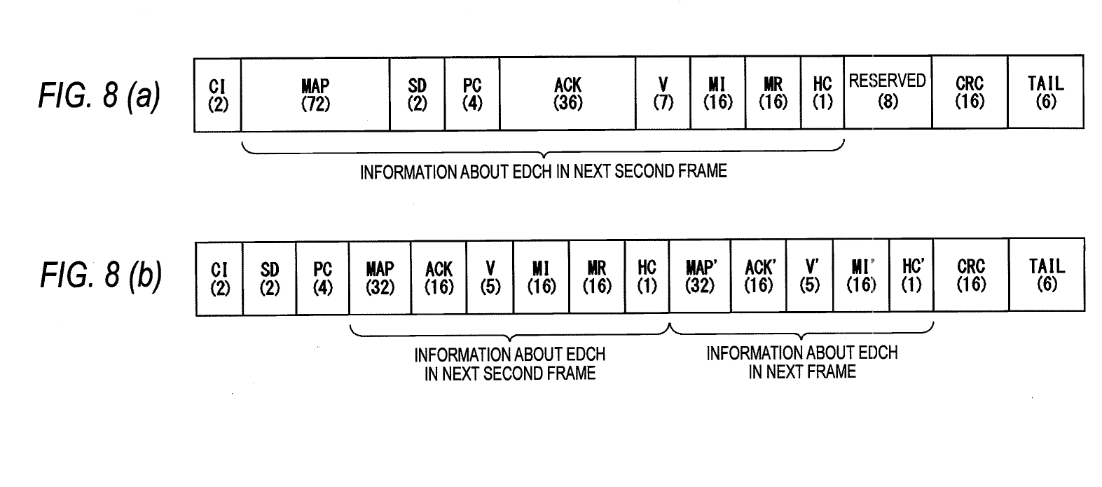

FIGS. 8(a) and 8(b) show a format of a downlink ECCH in the communication system (100). FIG. 8(a) shows a related format of a downlink ECCH. The numerals in parentheses indicate the number of bits. “MAP” is information about a burst, in which an EDCH is placed, in a frame. An EDCH includes a downlink EDCH and an uplink EDCH. “MI” is communication speed information about an EDCH. “ACK” is ACK information about a past uplink EDCH. The other information is not explained, in which “MAP”, “ACK”, “V”, “MI”, “MR” and “HC” correspond to EDCH information in the next second frame.

FIG. 8(b) shows a format of a downlink ECCH generated in the synthesis unit (58). As illustrated, “MAP”, “ACK”, “V”, “MI”, “MR” and “HC” correspond to EDCH information in the next second frame. “MAP′”, “ACK′”, “V′”, “MI′” and “HC′” correspond to EDCH information in the next frame. As described above, the former is inputted from the generation unit (54), and the latter is inputted from the delay unit (56). In addition, the number of bits acquired for each of the information in FIG. 8(b) is smaller than the number of bits acquired for each of the information in FIG. 8(a). The size of an ECCH is “186 bits,” which is predetermined. In addition, EDCH information is placed in divided areas of an ECCH to correspond with the number of frames to be responded to. As the number of frames increases, the number of EDCH information increases. In which case, the size of each of EDCH information becomes small such that the size of an ECCH maintains. Attention is now turned to FIG. 7.

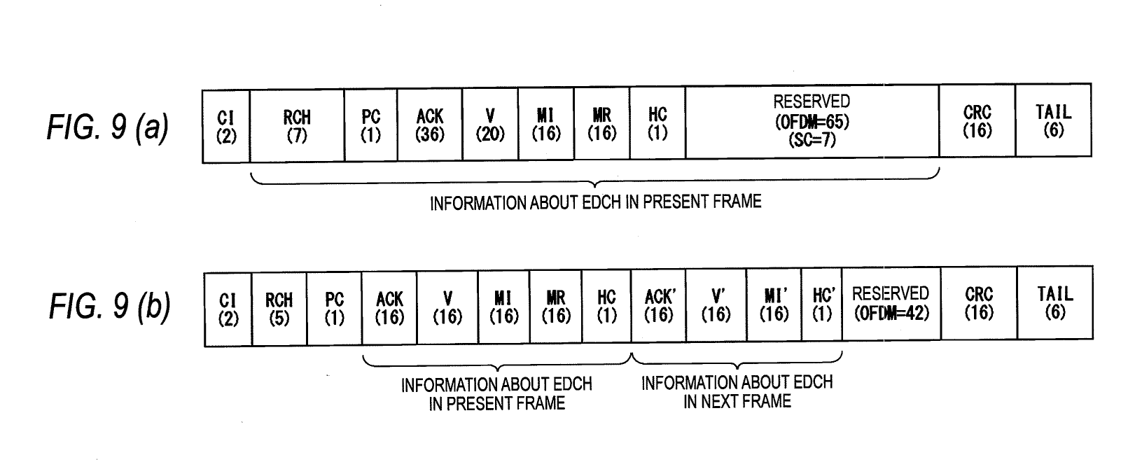

Hereinafter, a configuration of an uplink ECCH will be explained in compliance with the explanation of a downlink ECCH. An uplink ECCH is generated in the terminal device (12) not illustrated herein. FIGS. 9(a) and 9(b) show a format of an uplink ECCH in the communication system (100). FIG. 9(a) shows a related format of an uplink ECCH. As illustrated, EDCH information in the present frame is included. EDCH information included in an uplink ECCH has a structure in which MAP is excluded from EDCH information included in a downlink ECCH, and includes ACK information about a past downlink EDCH, instead of ACK information about a past uplink EDCH. FIG. 9(b) shows a format of an uplink ECCH generated in the terminal device (12) not illustrated herein. As illustrated, EDCH information in the present frame and EDCH information in the next frame are included. In other words, like a downlink ECCH, an uplink ECCH includes EDCH information in two continuous frames.

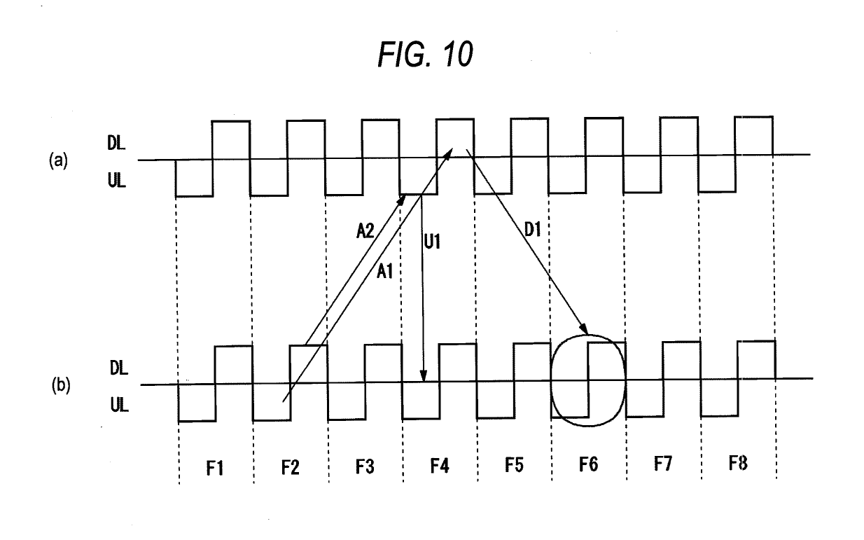

FIGS. 10(a) and 10(b) show transmission operation of an ECCH and an EDCH by a communication system comparable to the communication system (100). FIG. 10(a) corresponds to an ECCH. FIG. 10(b) corresponds to an EDCH. For explanation convenience, numbers have been assigned to frames in the order of frame positions such that the first frame to the last eighth frame are numbered as “F1” to “F8,” respectively. In addition, for clarity in drawings, in each of the frames illustrated in FIG. 2, only time slots, in which ECCHs and EDCHs are placed, are illustrated. The upper portion corresponds to downlink (DL), and the lower portion corresponds to uplink (UL).

Based on F4, the ECCH (DL) of F4 corresponds to FIG. 8(a). As described above, a downlink ECCH includes MAP and MI (for downlink), etc., of an EDCH in the next second frame, which are referred to as “D1.” In addition, the downlink ECCH includes ACK of an uplink EDCH in the previous second frame, which is referred to as “A1.” The ECCH (UL) of F4 corresponds FIG. 9(a). As described above, an uplink ECCH includes MI (for uplink), etc., in the present frame, which is referred to as “U1.” In addition, the uplink ECCH includes ACK of a downlink EDCH in the previous second frame, which is referred to as “A2.”

Under the circumstances, when an error occurs in a downlink ECCH, ACK/NACK becomes indefinite so that HARQ of an uplink EDCH in the next second frame cannot be transmitted. Further, MAP becomes indefinite so that the uplink EDCH in the next second frame cannot be transmitted. Furthermore, MAP and MI, etc., become indefinite so that a downlink EDCH in the next second frame cannot be received. On the other hand, when an error occurs in an uplink ECCH, ACK/NACK becomes indefinite so that HARQ of a downlink EDCH in the next second frame cannot be transmitted. Further, MI, etc., become indefinite so that an uplink EDCH in the present frame cannot be received.

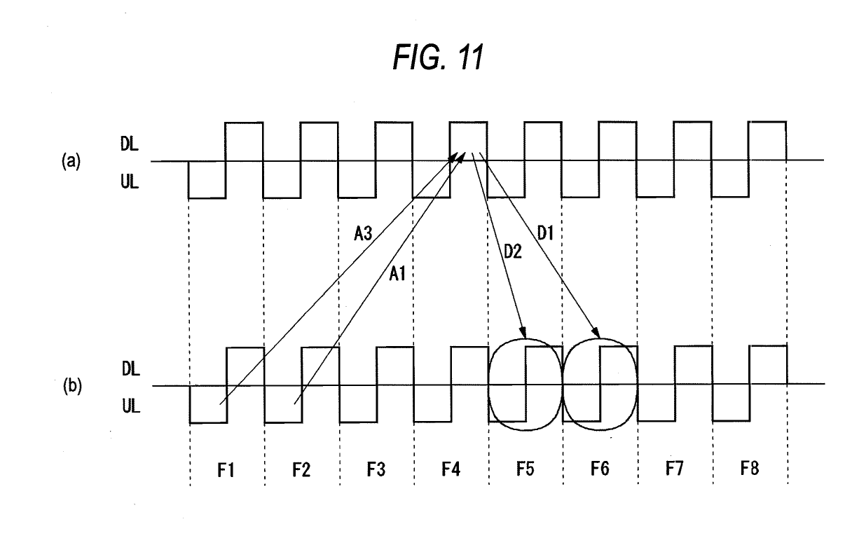

FIGS. 11(a) and 11(b) show transmission operation of a downlink ECCH in the communication system (100). This transmission operation corresponds to the operation in case of using the downlink ECCH as illustrated in FIG. 8(b). Since FIGS. 11(a) and 11(b) use the same reference marks as used in FIGS. 10(a) and 10(b), explanation thereof is omitted herein. In addition to MAP, etc., of an EDCH in the next second frame, a downlink ECCH includes MAP, etc., of an EDCH in the next frame. The former is referred to as “D1,” and the latter is referred to as “D2.” Further, in addition to ACK of an uplink EDCH in the previous second frame, the downlink ECCH includes ACK of an uplink EDCH in the previous third frame. The former is referred to as “A1,” and the latter is referred to as “A3.” Since the downlink ECCH includes information over a plurality of frames, redundancy increases while influence of an error is reduced.

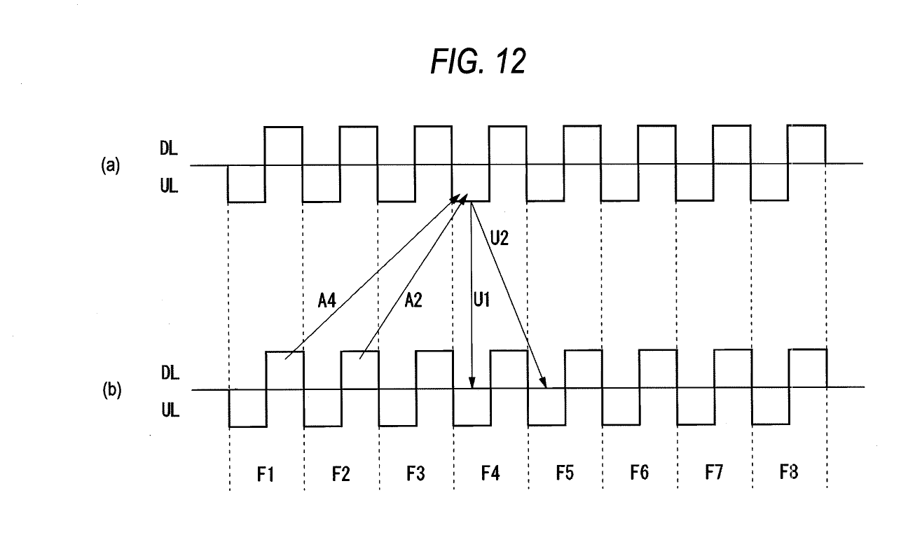

FIGS. 12(a) and 12(b) show transmission operation of an uplink ECCH in the communication system (100). This transmission operation corresponds to the operation in case of using the uplink ECCH as illustrated in FIG. 9(b). Since FIGS. 12(a) and 12(b) use the same reference marks as used in FIGS. 10(a) and 10(b), explanation thereof is omitted herein. In addition to MI, etc., of an EDCH in the present frame, the uplink ECCH includes MI, etc., of an EDCH in the next frame. The former is referred to as “U1,” and the latter is referred to as “U2.” Further, in addition to ACK of a downlink EDCH in the previous second frame, the uplink ECCH includes ACK of a downlink EDCH in the previous third frame. The former is referred to as “A2,” and the latter is referred to as “A4.” Since the uplink ECCH also includes information over a plurality of frames, redundancy increases while influence of an error is reduced.

This configuration can be expressed by any computer CPU, a memory, and other LSIs in view of hardware, and a program loaded in a memory and having a communication function, and so on in view of software. Herein, functional blocks expressed by the interconnections thereof have been illustrated. Thus, it is to be understood by one of ordinary skill in the art that the functional blocks can be expressed in many different forms of hardware, software, or a combination thereof.

The terminal device (12) illustrated in FIG. 1 has the same configuration as that of the base station apparatus (10) illustrated in FIG. 7 and performs operation in response to the base station apparatus (10). Differences in function between the terminal device (12) and the base station apparatus (10) exist in a ranging process, channel allocation, and ECC generation, etc. Since these differences have been explained, explanation thereof is omitted herein.

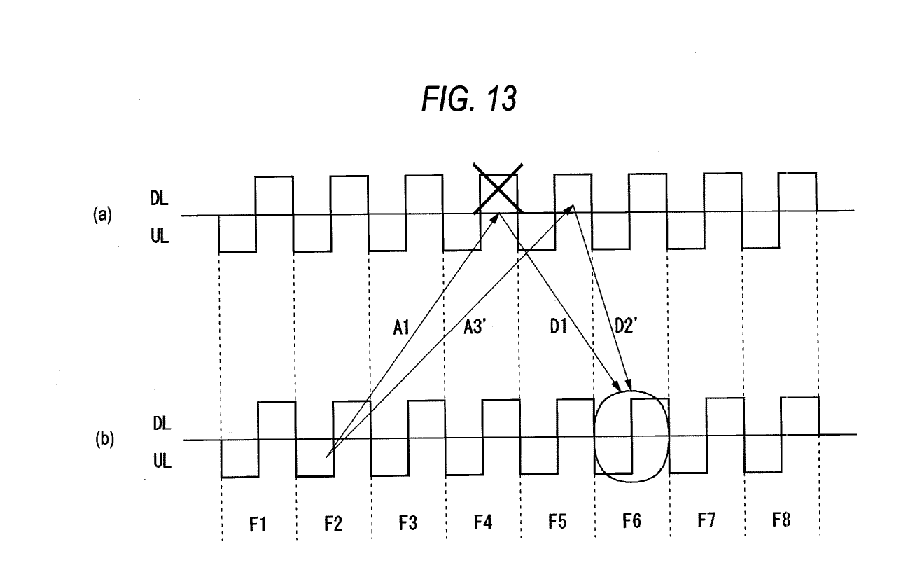

Operation of the communication system (100) according to all the configurations that have been described will be explained. FIGS. 13(a) and 13(b) show transmission operation in the communication system (100) when an error occurs in a downlink ECCH. This transmission operation corresponds to the operation in case of using the downlink ECCH illustrated in FIG. 8(b). FIGS. 13(a) and 13(b) use the same reference marks as used in FIGS. 10(a) and 10(b), which will not be explained herein. Based on F4, when an error occurs in a downlink ECCH, ACK of the uplink EDCH in F2 becomes indefinite. This means that “A1” is not exactly transmitted. In addition, when an error occurs in a downlink ECCH, MAP of the EDCH in F6 becomes indefinite. This means that “D1” is not exactly transmitted.

ACK of the uplink EDCH in F2 and MAP of the EDCH in F6 are also included in the downlink ECCH in F5 and correspond to “A3′” and “D2′” respectively. Due to the existence of the downlink ECCH in F5, the influence of the error to the downlink ECCH in F4 is reduced. In other words, the terminal device (12) receives the downlink ECCH in F5 such that it can acquire ACK of the uplink EDCH in F2 and transmit the uplink EDCH in F6. In addition, the terminal device (12) receives MAP, etc., in F6 such that it can receive the downlink EDCH in F6.

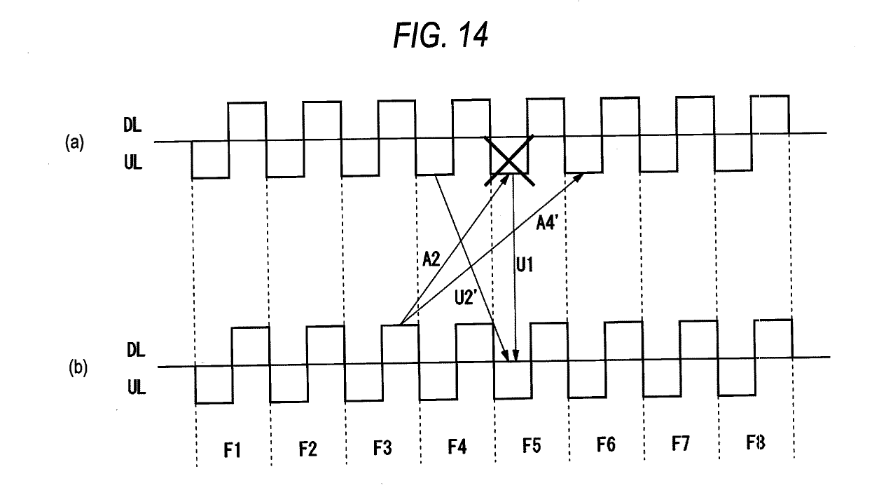

FIGS. 14(a) and 14(b) show transmission operation in the communication system (100) when an error occurs in an uplink ECCH. This transmission operation corresponds to the operation in case of using the uplink ECCH as illustrated in FIG. 9(b). FIGS. 14(a) and 14(b) use the same reference marks as used in FIGS. 10(a) and 10(b), which will not be explained herein. Unlike the foregoing explanation, based on F5, when an error occurs in an uplink ECCH, MI, etc., of the uplink EDCH in F5 become indefinite. This means that “U1” is not exactly transmitted. In addition, when an error occurs in an uplink ECCH, ACK of the downlink EDCH in F3 becomes indefinite. This means that “A2” is not exactly transmitted.

MI, etc., of the uplink EDCH in F5 are also included in the uplink ECCH in F4 and correspond to “U2′” As a result, the base station apparatus (10) can receive the uplink EDCH in F5. In addition, ACK of the downlink EDCH in F3 is also included in the uplink ECCH in F6 and corresponds to “A4′” As a result, the base station apparatus (10) receives ACK of the downlink EDCH in F3 one frame later and, at that time, generates MAP of the EDCH in F8. In addition, the terminal device (12) receives the downlink ECCH in F5 and thereby acquiring MAP, etc., of the downlink EDCH in F8 such that it can receive the downlink EDCH in F8.

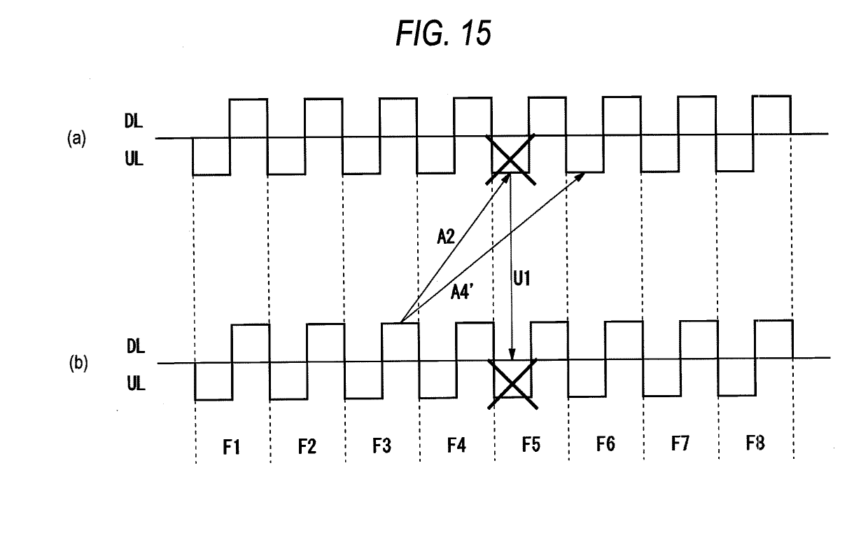

FIGS. 15(a) and 15(b) show other transmission operation in the communication system (100) when an error occurs in an uplink ECCH. This transmission operation corresponds to the operation in the case where MI, etc., of the uplink EDCH in the present frame and MI, etc., of the uplink EDCH in the previous frame are included in the uplink ECCH illustrated in FIG. 9(b). FIGS. 15(a) and 15(b) use the same reference marks as used in FIGS. 10(a) and 10(b), which will not be explained herein. Based on F5, when an error occurs in an uplink ECCH, MI, etc., of the uplink EDCH in F5 become indefinite. This means that “U1” is not exactly transmitted. In addition, when an error occurs in an uplink ECCH, ACK of the downlink EDCH in F3 becomes indefinite. This means that “A2” is not exactly transmitted.

ACK of the downlink EDCH in F3 is also included in the uplink ECCH in F6 and corresponds to “A4′” As a result, the base station apparatus (10) receives ACK of the downlink EDCH in F3 one frame later and, at that time, generates MAP of the EDCH in F8. In addition, as a result of MI, etc., of the uplink EDCH in F5 included in the uplink ECCH in F6, the base station apparatus (10) generates ACK of the uplink EDCH in F5. Furthermore, the terminal device (12) receives the downlink ECCH in F5 and thereby acquiring MAP, etc., of the downlink EDCH in F8 such that it can receive the downlink EDCH in F8.

According to an embodiment of the present invention, EDCH information over two frames are included in an ECCH, whereby even if an error occurs in one ECCH, another ECCH can notify the same EDCH information. Since even if an error occurs in one ECCH, another ECCH can notify the same EDCH information, it is possible to receive an EDCH even in case of an error in an ECCH. Since even if an error occurs in one ECCH, another ECCH can notify the same EDCH information, the influence of the error in the ECCH can be reduced. In addition, since ACK information is included in a plurality of ECCHs, even if an error occurs in one ECCH, the ACK information can be notified by other ECCHs.

Since MAP is included in a plurality of ECCHs, even if an error occurs in one ECCH, the MAP can be notified by other ECCHs. Since MI, etc., are included in a plurality of ECCHs, even if an error occurs in one ECCH, the MI, etc., can be notified by other ECCHs. Since identical EDCH information is included in continuous ECCHs, even if an error occurs in ECCHs, the EDCH information can be immediately notified. Since the size of EDCH information is adjusted according to the number of EDCH information to be included in an ECCH, it is possible to maintain the size of the ECCH. Since the size of an ECCH is maintained, the deterioration of transmission efficiency can be inhibited.

The present invention has been explained based on an embodiment of the present invention. It is to be understood by one of ordinary skill in the art that the embodiment is merely an exemplary embodiment and can be modified by any combination of elements or processes, which are within the scope of the present invention.

In an embodiment of the present invention, the synthesis unit (58) synthesizes two EDCH information to generate one ECCH. However, the present invention is not limited to this embodiment. The synthesis unit (58) may synthesize three or more EDCH information to generate one ECCH. In this case, the size of each of EDCH information decreases as the number of EDCH information increases. Since redundancy increases as a result of a modified embodiment of the present invention, influence of an error in an ECCH can be reduced.

Although the present invention has been described in detail with reference to a certain working embodiment, it is apparent to one of ordinary skill in the art that numerous modifications or variations to the present invention is possible within the technical gist and scope of the present invention. This application is based on Japanese Patent Application No. 2008-056614 filed on Mar. 6, 2008, the full disclosures of which are hereby incorporated by reference.

### INDUSTRIAL APPLICABILITY

According to the present invention, even if an error occurs in an ECCH, influence to an EDCH can be reduced.

1. A base station apparatus comprising:
an allocation unit configured to allocate different channels, in each frame, to data for communication between the base station apparatus and a terminal device and control information of the data, respectively, the frames, which are formed with a plurality of channels, being continuously arranged; and
a communication unit configured to communicate with the terminal device using the control information and the data to which channel has been allocated by the allocation unit,
wherein
the control information, to which the channel has been allocated by the allocation unit, and which is within one frame, corresponds to data over a plurality of frames.

2. The base station apparatus according to claim 1,
wherein
the control information, to which the channel has been allocated by the allocation unit, and which is within one frame, corresponds to data over continuous frames.

3. The base station apparatus according to claim 1,
wherein
the control information, to which the channel has been allocated by the allocation unit, has a predetermined size and comprises areas divided to correspond with the number of frames to be responded to.

4. The base station apparatus according to claim 1,
wherein
the allocation unit comprises a generation unit, a delay unit and a synthesis unit,
wherein
the generation unit generates information, which is a base of the control information, and outputs the information to the delay unit and the synthesis unit;
the delay unit receives the information from the generation unit, delays the received information by a predetermined frame, and then outputs the information to the synthesis unit; and
the synthesis unit synthesizes the information received from the generation unit and the information received from the delay unit to generate the control information.

5. A communication method comprising:
allocating different channels, in each frame, to data for communication with a terminal device and to control information of the data, respectively, the frames, which are formed with a plurality of channels, being continuously arranged; and
implementing communication with the terminal device using the control information and data to which channel has been allocated,
wherein
the control information, to which the channel has been allocated, and which is within one frame, correspond to data over a plurality of frames.
